(19) United States
(12) Patent Application Publication
(10) Pub. No.: US 2024/0132755 A1
(43) Pub. Date: Apr. 25, 2024

(54) HOT MELT ADHESIVE

(71) Applicant: Henkel AG & Co. KGaA, Dusseldorf (DE)

(72) Inventor: MASAHIRO MORIGUCHI, Osaka (JP)

(21) Appl. No.: 18/531,919

(22) Filed: Dec. 7, 2023

Related U.S. Application Data
(63) Continuation of application No. PCT/JP22/22776, filed on Jun. 6, 2022.

(30) Foreign Application Priority Data
Jun. 7, 2021 (JP) 2021-096103

(51) Int. Cl. C09J 7/35; C09J 193/04

(52) U.S. Cl. CPC C09J 7/35; C09J 193/04; C09J 2301/304; C09J 2301/414; C09J 2423/00; C09J 2453/00; C09J 2493/00

(57) ABSTRACT

To provide a hot melt adhesive having excellent coatability, adhesiveness and creep resistance, being able to bond and retain an elastic material to a material containing biodegradable plastics, and a disposable product comprising the hot melt adhesive. A hot melt adhesive comprising (A) a thermoplastic block copolymer which is a copolymer of vinyl aromatic hydrocarbons and conjugated diene compounds, and (B) a tackifying resin, wherein (A) the thermoplastic block copolymer comprises: (A1) a styrene block copolymer having a styrene content of 35 to 50% by mass; and (A2) a styrene block copolymer having a styrene content of more than 10% by mass and less than 35% by mass; (B) the tackifying resin comprises: (B1) a natural resin; and the component (B1) being contained in an amount of 20 parts by mass or more based on 100 parts by mass of the component (B).

### TECHNICAL FIELD

The present invention relates to a hot melt adhesive, and more particularly to a hot melt adhesive for use in the field of disposable products such as disposable diapers and napkins.

### BACKGROUND ART

Hot melt adhesives are used in disposable products such as disposable diapers and napkins. Hot melt adhesives are applied to substrates such as nonwoven fabric, tissue and polyethylene film, and a plurality of these substrates is combined to produce a disposable product.

As the hot melt adhesive, synthetic rubber based hot melt adhesives composed as a main component of thermoplastic block copolymers and olefin based hot melt adhesives such as ethylene/propylene/butene copolymers may be mainly exemplified. Considering coatability, cohesive force and the like, synthetic rubber-based hot melt adhesives may be used rather than olefin-based adhesives.

Generally, hot melt adhesives include a base polymer and a plasticizer. It has been studied to reduce the viscosity of the hot melt adhesive and improve the coating suitability by reducing the amount of the base polymer and increasing the amount of the plasticizer.

However, a hot melt adhesive containing a large amount of the plasticizer has a problem that it has a poor balance between the cohesive force and the tack and the adhesiveness to a paper diaper member (for example, a polyethylene film) is lowered.

As a kind of disposable diaper, there is the one in which a rubber thread is incorporated. A hot melt adhesive is used when a stretched rubber thread is bonded to a disposable diaper body. The disposable diaper body being composed of a material having no elasticity, the disposable diaper body to which the rubber thread is bonded is folded by the shrinkage force of the rubber thread when the rubber thread shrinks. As a result, the elastic force of the rubber thread is applied to the disposable diaper body, and the disposable diaper fits the body.

A hot melt adhesive that bonds an elastic material such as a rubber thread to a disposable diaper body needs to have excellent creep resistance. When an elastic material is bonded to a paper diaper body using a hot melt adhesive with insufficient creep resistance, the hot melt adhesive is stretched by the shrinkage force of the elastic material, thus the elastic material becomes unable to stay at the position where it is bonded. As a result, only the elastic material shrinks without the paper diaper body, and even if the elastic material shrinks, the paper diaper body is not folded, and the paper diaper does not fit the body. Therefore, the hot melt adhesive is required to have excellent creep resistance.

Patent Documents 1 to 3 disclose synthetic rubber-based hot melt adhesives based on styrene-based block copolymers.

Patent Document 1 discloses a hot melt composition having a styrene-based block copolymer and a plasticizer (claim 1). The styrene-based block copolymer contains a high molecular weight component and a low molecular weight component in a predetermined ratio. The hot melt adhesive of Patent Document 1 is excellent in stretch properties and stretch recovery properties after being stretched and is intended to be used as an elastic member of an elastic laminate of a sanitary material. It has been shown with reference to the characteristic evaluation results of Examples (Table 1 in [0093]) that the hot melt composition of Patent Document 1 is excellent in breaking elongation and permanent strain.

On the other hand, Patent Document 1 does not mention the adhesiveness of the hot melt composition. The hot melt composition shown in Table 1 not containing a tackifying resin, it has a low tack, and the performance of bonding to an adherend such as a diaper body, for example, is considered to be insufficient.

Patent Document 2 describes low application temperature hot melt adhesive compositions including a styrene block copolymer having a diblock content of about 10% by weight or less in a specific amount (abstract). The hot melt adhesive composition of Patent Document 2 has a low viscosity, but has mechanical properties (for example, peeling force and creep) equivalent to those of a hot melt adhesive having a higher viscosity, and is used for uses such as structural purposes, and positioning purposes, in disposable articles.

On the other hand, referring to the compositions of Examples (Tables 1 to 4 of [0094] to [0097]), the hot melt adhesive compositions of Patent Document 2 contain a large amount of tackifying resin and oil, and have a low creep resistance. For example, in the application of incorporating the rubber thread into a disposable product, it is considered that the performance of bonding and keeping the rubber thread to the adherend is insufficient.

Patent Document 3 discloses a hot melt adhesive which has a radial type styrene block copolymer and a linear type styrene block copolymer, and employed for fixing a rubber thread to a disposable product ([Claim 1], [Claim 3]). As shown in the examples, the hot melt adhesive of Patent Document 3 has excellent creep resistance, and is able to bond and keep a rubber thread to the adherend when the rubber thread is incorporated into a disposable product ([0096] to [0100]).

### PRIOR ART DOCUMENTS

### Patent Documents

[Patent Document 1] WO 2020/110921 A
[Patent Document 2] JP 2018-514604 A
[Patent Document 3] JP 2016-442899 A

### SUMMARY OF INVENTION

### Problem to be Solved by Invention

In recent years, biodegradable plastics may be used as a material for disposable products in order to reduce the environmental load. Such a material includes, for example, polylactic acid-based nonwoven fabric. However, conventional hot melt adhesives have insufficient adhesiveness to a material containing biodegradable plastics, and it is difficult to bond and keep an elastic material such as a rubber thread to a material containing biodegradable plastics.

It is an object of the present invention to provide a hot melt adhesive which is excellent in coatability, adhesiveness and creep resistance, and is able to bond and keep an elastic material to a material containing biodegradable plastics, and a disposable product comprising the hot melt adhesive.

### Means for Solving the Problem

The present invention and preferred embodiments of the present invention are as follows.
1. A hot melt adhesive comprising (A) a thermoplastic block copolymer which is a copolymer of vinyl aromatic hydrocarbons and conjugated diene compounds, and (B) a tackifying resin, wherein
(A) the thermoplastic block copolymer comprises:
(A1) a styrene block copolymer having a styrene content of 35 to 50% by mass; and
(A2) a styrene block copolymer having a styrene content of more than 10% by mass and less than 35% by mass;
(B) the tackifying resin comprises:
(B1) a natural resin; and
the component (B1) being contained in an amount of 20 parts by mass or more based on 100 parts by mass of the component (B).
2. The hot melt adhesive according to 1, wherein 50 to 90 parts by mass or more of the component (B1) are contained in 100 parts by mass parts of the component (B).
3. The hot melt adhesive according to 1 or 2, wherein (B1) the natural resin comprises a rosin ester.
4. The hot melt adhesive according to any one of 1 to 3, wherein (B) the tackifying resin further comprises (B2) a petroleum resin.
5. The hot melt adhesive according to 4, wherein (B2) the petroleum resin contains a hydrogenated petroleum resin having a softening point of 100° C. or more.
6. The hot melt adhesive according to any one of 1 to 5, wherein 60 to 90 parts by mass of the component (A1) are contained in a total of 100 parts by mass of the component (A1) and the component (A2).
7. The hot melt adhesive according to any one of 1 to 6, wherein the component (A1) is a linear type styrene block copolymer.
8. The hot melt adhesive according to any one of 1 to 7, wherein the component (A) is contained in an amount of 30 to 80 parts by mass based on 100 parts by mass of the component (B).
9. The hot melt adhesive according to any of 1 to 8, for use in fixing an elastic material to the disposable product body.
10. A disposable product comprising the hot melt adhesive according to any of 1 to 9, the hot melt adhesive being applied thereon.

### Effect of Invention

The hot melt adhesive of the present invention has excellent coatability, adhesiveness and creep resistance, and is able to bond and keep an elastic material to a material containing biodegradable plastics. By using the hot melt adhesive of the present invention, it is also possible to bond and keep an elastic material to a materials containing biodegradable plastics, and a disposable product with a small load on the environment may be manufactured.

### EMBODIMENTS OF THE INVENTION

The hot melt adhesive of the present invention contains (A) a thermoplastic block copolymer and (B) a tackifying resin.

### <(A) Thermoplastic Block Copolymer>

In the hot melt adhesive of the present invention, (A) the thermoplastic block copolymer is a copolymer in which vinyl aromatic hydrocarbons and conjugated diene compounds are block-copolymerized. (A) The thermoplastic block copolymer is usually a resin composition containing a copolymer having a vinyl aromatic hydrocarbon block and a conjugated diene compound block.

Here, the “vinyl aromatic hydrocarbon” means an aromatic hydrocarbon compound having a vinyl group, and specifically, for example, styrene, o-methylstyrene, p-methylstyrene, p-tert-butylstyrene, 1,3-dimethylstyrene, α-methylstyrene, vinylnaphthalene, vinylanthracene and the like may be exemplified. The most preferred among these is styrene. These vinyl aromatic hydrocarbons may be used alone or in combination.

The “conjugated diene compound” means a diolefin compound having at least a pair of conjugated double bonds.

Specifically, for example, 1,3-butadiene, 2-methyl-1,3-butadiene (or isoprene), 2,3-dimethyl-1,3-butadiene, 1,3-pentaziene and 1,3-hexadiene may be exemplified as the “conjugated diene compound”. The preferred among these are 1,3-butadiene and 2-methyl-1,3-butadiene. These conjugated diene compounds may be used alone or in combination.

(A) The thermoplastic block copolymer according to the present invention may be an unhydrogenated product or a hydrogenated product.

Examples of (A) the unhydrogenated product of the thermoplastic block copolymer includes, specifically, those in which a block based on conjugated diene compounds is not hydrogenated. Examples of (A) the hydrogenated product of the thermoplastic block copolymer include, specifically, a block copolymer to which all or part of a block based on conjugated diene compounds is hydrogenated.

The hydrogenated ratio of “(A) the hydrogenated product of the thermoplastic block copolymer” may be indicated by the “hydrogenation ratio”. The “hydrogenation ratio” of “(A) the hydrogenated product of the thermoplastic block copolymer” means the ratio of the double bonds having been converted to saturated hydrocarbon bonds by hydrogenation, based on the total aliphatic double bonds contained in the blocks derived from the conjugated diene compounds. This “hydrogenation ratio” may be measured by an infrared spectrophotometer, a nuclear magnetic resonance apparatus, or the like.

Examples of (A) the unhydrogenated product of the thermoplastic block copolymer include, specifically, a styrene-isoprene block copolymer (also referred to as “SIS”) and a styrene-butadiene block copolymer (also referred to as “SBS”). Examples of (A) the hydrogenated product of the thermoplastic block copolymer include, specifically, a hydrogenated styrene-isoprene block copolymer (also referred to as “SEPS”) and a hydrogenated styrene-butadiene block copolymer (also referred to as “SEBS”).

As long as the object of the present invention is achieved, the structure of (A) the thermoplastic block copolymer may be a linear type or a radial type.

In the present description, the “linear type” means a linear structure. The linear type styrene block copolymer is a linear copolymer in which a styrene block and a conjugated diene block are bonded.

The radial type styrene block copolymer is a branched styrene block copolymer having a structure in which a plurality of linear type styrene block copolymers projects radially around a coupling agent.

The specific structure of the radial styrene block copolymer is shown below.

[Chemical Formula 1]

(S-E)ₙY (1)

In the formula, n is an integer of 2 or more, S is a styrene block, E is a conjugated diene compound block, and Y is a coupling agent. n is preferably 3 or 4, and n is particularly preferably 3. Butadiene or isoprene is preferred as the conjugated diene compound.

The styrene block copolymer is a resin composition and contains the styrene-conjugated diene block copolymer represented by formula (2) in a certain ratio.

[Chemical Formula 2]

S-E (2)

In the formula, S and E have the same meaning as above. The styrene-conjugated diene block copolymer represented by formula (2) is sometimes referred to as a “diblock”.

The coupling agent is a polyfunctional compound that radially bonds linear type styrene block copolymers. The type of coupling agent is not particularly limited.

Examples of the coupling agent include silane compounds such as halogenated silanes and alkoxysilanes; tin compounds such as tin halides; polycarboxylate esters; epoxy compounds such as epoxidized soybean oils; acrylates such as pentaerythritol tetraacrylate; epoxysilanes; divinyl compounds such as divinylbenzene; and the like. Specific examples include trichlorosilane, tribromosilane, tetrachlorosilane, tetrabromosilane, methyltrimethoxysilane, ethyltrimethoxysilane, vinyltrimethoxysilane, vinyltriethoxysilane, tetramethoxysilane, tetraethoxysilane, and tetrachlorotin, diethyladipate and the like.

(A) The thermoplastic block copolymer comprises (A1) a styrene block copolymer having a styrene content of 35 to 50% by mass, and (A2) a styrene block copolymer having a styrene content of more than 10% by mass and less than 35% by mass.

In the present description, the term “styrene content” means the ratio of the styrene block contained in the component (A).

In the hot melt adhesive of the present invention, the styrene contents of the component (A1) and the component (A2) are in the above range, and thereby, the balance between the cohesive force and the tack becomes better, and the adhesiveness is improved.

The styrene content of the component (A1) is in the above range, so that the hot melt adhesive has increased retention force (cohesive force) and excellent creep resistance, and thereby, the hot melt adhesive is able to bond and keep an elastic material having high stretch ratio to the disposable product body. The styrene content of the component (A2) is in the above range, and thereby, the balance between the tack and the cohesive force of the hot melt adhesive is optimized, and the adhesiveness is improved.

(A) The thermoplastic block copolymer of the present invention has a diblock content of preferably 0 to 90% by mass, and more preferably 15 to 85% by mass.

The “diblock content” means the ratio of the styrene-conjugated diene compound block copolymer of formula (2) contained in the component (A).

The diblock content of the component (A1) is preferably 0 to 80% by mass, and more preferably 0 to 65% by mass. The diblock content of the component (A2) is preferably 0 to 70% by mass, and more preferably 0 to 65% by mass.

In the hot melt adhesive of the present invention, the diblock contents of the component (A1) and the component (A2) are in the above ranges, and thereby, the balance between the cohesive force and the tack becomes better, resulting in excellent adhesiveness.

The component (A1) is preferably a linear type styrene block copolymer. The component (A1) having a structure of linear type, the hot melt adhesive of the present invention is able to bond and keep more strongly an elastic material to a material containing biodegradable plastics.

Commercially available products may be used as the component (A1). Examples of the commercially available product include Quintac 3390 (trade name) manufactured by ZEON CORPORATION, LCY5562 (trade name), LCY3545 (trade name) manufactured by LCY GRIT CORPORATION, Taipol 4270 manufactured by TSRC Corporation, and N308 (trade name) manufactured by Asahi Kasei Corporation.

The component (A2) preferably contains at least one selected from styrene-butadiene block copolymers and styrene-isoprene block copolymers, and more preferably contains styrene-isoprene block copolymers. In the hot melt adhesive of the present invention, the component (A2) contains the styrene-isoprene block copolymers, so that the balance between the tack and the cohesive force is optimized, resulting in excellent adhesiveness.

Commercially available products may be used as the component (A2). For example, Asaprene T432 (trade name), Asaprene T436 (trade name) manufactured by Asahi Kasei Corporation, Kraton D1161 (trade name) manufactured by Kraton Corporation, VECTOR 4213NS (trade name) manufactured by TSRC Corporation, JH8291 (trade name) manufactured by Jinhai Chemical Corporation, Quintac 3270 (trade name) manufactured by ZEON CORPORATION may be exemplified.

In the hot melt adhesive of the present invention, 60 to 90 parts by mass of the component (A1) are preferably contained in 100 parts by mass of a total of the component (A1) and the component (A2). The content of the component (A1) being 60 parts by mass or more, the creep resistance of the hot melt adhesive is further improved, and it being 90 parts by mass or less, deterioration of the adhesiveness is prevented. The content of the component (A1) is in the above range, so that the hot melt adhesive has increased cohesive force, and thereby, the hot melt adhesive is able to bond and keep more easily an elastic material to a disposable product. The content of the component (A1) in 100 parts by mass of a total of the component (A1) and the component (A2) is preferably 67 to 86 parts by mass, and more preferably 70 to 80 parts by mass.

### <(B) Tackifying Resin>

In the hot melt adhesive of the present invention, (B) the tackifying resin contains (B1) a natural resin. (B1) The natural resin is contained in an amount of 20 parts by mass or more of (B1) the natural resin in 100 parts by mass of (B) the tackifying resin. The content of (B1) the natural resin in (B) the tackifying resin is preferably 25 to 90 parts by mass, more preferably 50 to 90 parts by mass, further preferably 56 to 85 parts by mass, and most preferably 73 to 83 parts by mass.

(B1) The natural resin imparts an appropriate tack to the hot melt adhesive while maintaining the cohesive force, and improves the adhesiveness of the hot melt adhesive to a material containing biodegradable plastics. As a result, by including (B1) the natural resin in the above-mentioned ratio, the hot melt adhesive of the present invention is able to bond and keep an elastic material to a material containing biodegradable plastics.

In the present description, the “natural resin” refers to a resinous substance secreted by the physiological or pathological action of animals and plants, or extracted from those tissues, or a modified product of the extracted resinous substance. (B1) The natural resins are mainly classified into a rosin type and a terpene type.

The rosin type includes rosin and rosin derivatives (hydrogenated rosins, rosin esters, disproportionated rosins, polymerized rosins, maleated rosins, maleic acid-modified rosin resins, and rosin-modified phenolic resins).

The terpene type includes terpene resins, terpene-modified phenolic resins, aromatic-modified terpene resins, and hydrogenated terpene resins.

(B1) The natural resin preferably has a biomass content of 50% or more, more preferably 65% or more, and most preferably 80% or more.

The biomass degree of the component (B1) being in the above range, the biomass degree of the hot melt adhesive of the present invention is increased, resulting in excellent adhesiveness to a material containing biodegradable plastics.

In the present specification, the “biomass degree” is a value calculated by measuring the content of carbon C14 contained only in a biological substance, and is measured by an accelerator mass spectrometer (AMS). C14 is not included in fossil resources such as oil and coal. By calculating the C14 content of the target substance (component (B1)), the biomass degree of the component (B1) can be calculated, and the biomass degree of the entire hot melt adhesive can be calculated from the biomass degree of the component (B1).

As (B1) natural resins, commercially available products may be used. The commercially available products include SYLVALITE 9100 (trade name), SYLVALITE 6100 (trade name), SYLVARES TPM1115 (trade name) manufactured by Kraton Corporation, KE100L (trade name) manufactured by Guangdong KCMO Corporation, Pine Crystal KR612 (trade name), Pine Crystal KE100 (trade name) manufactured by Arakawa Chemical Industries, Ltd.), YS Polystar U115 (trade name), YS Polystar T130 (trade name), YS Polystar S145 (trade name) manufactured by YASUHAPA CHEMICAL CO., LTD., and the like.

In the present invention, (B1) the natural resin preferably contains a rosin ester. Containing a rosin ester, the hot melt adhesive of the present has improved adhesiveness to a material containing biodegradable plastics, and is able to bond and keep more strongly an elastic material to a material containing biodegradable plastics.

(B) The tackifying resin preferably contains (B2) a petroleum resin together with (B1) the natural resin. (B2) The petroleum resin has the effect of increasing the creep resistance of the hot melt adhesive.

The hot melt adhesive of the present invention contains both the component (B1) and the component (B2), so that both the adhesiveness to the material containing biodegradable plastics and the creep resistance are improved, thus an elastic material is able to bond and stay more strongly at a material containing biodegradable plastics.

In the present specification, the “petroleum resin” means a synthetic resin produced by polymerizing an unsaturated petroleum fraction. A highly unsaturated C5 fraction produced as a by-product by naphtha cracking, and the like are employed as main raw materials. The raw materials are then polymerized with Friedel-Crafts catalyst to obtain the petroleum resin.

(B2) The petroleum resins are roughly classified into the aliphatic type, aromatic type, copolymer type, hydrogenated type and the like. The aliphatic type petroleum resin is a resin made from C5 fraction of naphtha cracked oil. The aromatic type petroleum resin is a resin made from C9 fraction of naphtha cracked oil. The copolymer type petroleum resin is made from a copolymer resin of C5-C9 fractions having both properties of the aliphatic petroleum resin and the aromatic petroleum resin. The hydrogenated petroleum resin is obtained by hydrogenating an aromatic petroleum resin or a dicyclopentadiene-based polymerized resin.

Commercially available petroleum resins (B2) include T-Rez HA103 (trade name), T-Rez HB125 (trade name), T-Rez HC103 (trade name) manufactured by ENEOS Corporation, HD1120 (trade name), HD1100 (trade name) manufactured by Zibo Luhua Hongjin New Material Corporation, ECR5600 (trade name) manufactured by Exxon Mobil Corporation, Eastotac H130 (trade name), Plastolyn290LV (trade name) manufactured by Eastman Corporation, SUKOREZ SU420 (trade name), SUKOREZ SU400 (trade name) manufactured by KOLON Industries, Inc., Imarve S100 (trade name), Imarve P125 (trade name) manufactured by Idemitsu Kosan Co., Ltd., Alcon M100 (trade name), Alcon P115 (trade name) manufactured by Arakawa Chemical Industries, Ltd. and the like.

In the present invention, the softening temperature of (B2) the petroleum resin is preferably 100° C. or more, and more preferably 120° C. or more. In the hot melt adhesive of the present invention, the softening point of the component (B2) is in the above range, and thereby, the hot melt adhesive of the present invention has excellent heat resistance and excellent coatability at about 140° C. to 160° C.

Based on 100 parts by mass of (B) the tackifying resin, 30 to 80 parts by mass of (A) the thermoplastic block copolymer is contained in the hot melt adhesive. The content of (A) the thermoplastic block copolymer is preferably 35 to 65 parts by mass, and more preferably 40 to 55 parts by mass. (B) The tackifying resin is contained so that the content of (A) the thermoplastic block copolymer is in the above range, and thereby, the hot melt adhesive of the present invention has improved performance for bonding and keeping an elastic material to a material containing biodegradable plastics.

### <(C) Plasticizer>

The hot melt adhesive of the present invention preferably contains (C) a plasticizer in addition to the component (A) and the component (B). The plasticizer is formulated for the purpose of lowering the melt viscosity of the hot melt adhesive, imparting flexibility thereof, and improving the wetting to the adherend, thereby improving the coatability of the hot melt adhesive. (C) The plasticizer may include, for example, a paraffinic oil, a naphthenic oil and an aromatic oil. (C) The plasticizer is contained in the hot melt adhesive in an amount of 30 parts by mass or less, and more preferably 25 parts by mass or less, based on 100 parts by mass of (B) the tackifying resin.

Commercially available products may be used as the plasticizer. For example, White Oil Broom350 (trade name) manufactured by Kukdong Oil & Chem, Diana Fresia S32 (trade name), Diana Process Oil PW-90 (trade name), DN Oil KP-68 (trade name) manufactured by Idemitsu Kosan Co., Ltd., Enerper M1930 (trade name) manufactured by BP Chemicals, Kaydol (trade name) manufactured by Crompton Limited, Primol 352 (trade name) manufactured by ESSO CORPORATION, Process Oil NS100 manufactured by Idemitsu Kosan Co., Ltd., and KN4010 (trade name) manufactured by Petro China Company Limited may be exemplified. These plasticizers may be used alone or in combination.

The hot melt adhesive according to the present invention may further contain various additives as necessary. As such various additives, for example, stabilizers and fine particle fillers may be exemplified.

The stabilizer is formulated in order to improve the stability of the hot melt adhesive by preventing the decrease in molecular weight, gelation, coloring, generation of odor and the like of the hot melt adhesive due to heat. It is not particularly limited as long as the intended hot melt adhesive of the present invention may be obtained. For example, antioxidants and ultraviolet absorbers may be exemplified as the “stabilizer”.

The ultraviolet absorbers are used to improve the light resistance of hot melt adhesives. The “antioxidants” are used to prevent oxidative deterioration of hot melt adhesives. The antioxidants and ultraviolet absorbers may be used without being particularly limited as long as they are generally used for disposable products, and the intended disposable products described below may be obtained.

As the antioxidants, for example, phenolic antioxidants, sulfur antioxidants, and phosphoric antioxidants may be exemplified. As the ultraviolet absorbers, for example, benzotriazole-type ultraviolet absorbers and benzophenone-type ultraviolet absorbers may be exemplified. Furthermore, lactone-based stabilizers may be added. These may be used alone or in combination.

Commercially available products may be used as the stabilizer. For example, SUMILIZER G4 (trade name), SUMILIZER TPD (trade name) and SUMILIZER TPS (trade name) manufactured by SUMITOMO CHEMICAL COMPANY, LIMITED, Irganox 1010 (trade name), Irganox HP2225FF (trade name), Irgafos 168 (trade name) and Irganox 1520 (trade name) manufactured by Ciba Specialty Chemicals Co., and JF77 (trade name) manufactured by JOHOKU CHEMICAL CO., LTD. may be exemplified. These stabilizers may be used alone or in combination.

The hot melt adhesive of the present invention is produced by formulating the above components in a predetermined ratio, further formulating various additives as necessary, heating, melting and mixing them. Specifically, it is produced by putting the above-mentioned components into a melting and mixing kettle equipped with a stirrer, and heating and mixing them.

The obtained hot melt adhesive has a melt viscosity at 160° C. of preferably 50,000 mPa-s or less, and more preferably 2000 to 8000 mPa-s. The “melt viscosity” means the viscosity of the melt of the hot melt adhesive. It is measured with a Brookfield RVT type viscometer (spindle No. 27).

Further, in the method for evaluating the applied length retention properties (creep resistance) of a rubber thread described in Examples, the hot melt adhesive according to the present invention preferably has a retention rate of 80% or more, and more preferably a value exceeding 90%. In the hot melt adhesive, when the retention rate reaches 80% or more, by bonding and keeping the stretched rubber string, a material with no elasticity is able to stretch and shrink, which is suitable for use in disposable products.

The hot melt adhesive according to the present invention is widely used for paper processing, bookbinding, disposable products and the like, but is mainly used for disposable products. The “disposable product” is not particularly limited as long as it is a so-called sanitary material, for example. As the sanitary material, disposable diapers, sanitary napkins, pet sheets, hospital gowns, and surgical lab coats and the like may be specifically exemplified.

The hot melt adhesive of the present invention is preferably used for the purpose of bonding a stretched elastic material to a product body when an elastic material is incorporated to produce the disposable product.

In another gist of the present invention, there is provided a disposable product obtained by applying the above-mentioned hot melt adhesive. The disposable product is composed by bonding at least one member selected from the group consisting of woven fabric, nonwoven fabric, rubber, resin and paper, and a polyolefin film, using the hot melt adhesive according to the present invention. The polyolefin film is preferably a polyethylene film because of its durability and cost.

Considering the environmental load, a material containing biodegradable plastics is preferable as the member of the disposable product.

A specific example of the material containing biodegradable plastics includes biodegradable plastic nonwoven fabric. The biodegradable plastic nonwoven fabric means a sheet material having a non-woven web layer containing long fibers of biodegradable plastic. Specific examples of the biodegradable plastic include polylactic acid, poly-ε-caprolactone (PCL), polyglycolic acid, cellulose, chitin, viscose rayon, and collagen.

In a disposable product manufacturing line, a hot melt adhesive is generally applied to at least one of various members (for example, nonwoven fabric and the like) of a disposable product and a polyolefin film, and the film and the member are pressure bonded to manufacture a disposable product. At the time of application, the hot melt adhesive may be squirted from various squirts and used.

In the present invention, the coating may be either contact coating or non-contact coating.

“Contact coating” is a coating method in which an ejector is brought into contact with a member or a film when applying a hot melt adhesive. Specifically, V-slit coating is cited.

“Non-contact coating” is a coating method in which the ejector is not brought into contact with a member or a film when applying a hot melt adhesive. For example, spiral coating that may be applied in a spiral shape, omega coating and control seam coating that may be applied in a wavy shape, slot spray coating and curtain spray coating that may be applied in a planar shape, dot coating that may be applied in a dot form and the like may be exemplified as specific non-contact coating methods.

Hereinafter, the present invention will be described more specifically and in more detail with reference to Examples and Comparative Examples, but these Examples are merely one aspect of the present invention, and the present invention is not limited by these examples. In the description of the examples, unless otherwise specified, the portion that does not consider the solvent is used as a reference for parts by mass and % by mass.

### EXAMPLES

The components used in the present examples are shown below.
(A) Thermoplastic block copolymer
(A1) Styrene block copolymer having a styrene content of 35 to 50% by mass
(A1-1) Linear type styrene-isoprene block copolymer (Quintac 3390 (trade name), styrene content 48% by mass, diblock content 0% by mass (triblock content 100% by mass), manufactured by ZEON CORPORATION)
(A1-2) Linear type styrene-isoprene block copolymer (LCY5562 (trade name), styrene content 45% by mass, diblock content 0% by mass (triblock content 100% by mass), manufactured by LCY GRIT Corporation)
(A1-3) Linear type styrene-butadiene block copolymer (LCY3545 (trade name), styrene content 43% by mass, diblock 60% by mass, manufactured by LCY GRIT Corporation)
(A1-4) Linear type styrene-butadiene block copolymer (Taipol 4270 (trade name), styrene content 37% by mass, diblock content 70% by mass, manufactured by TSRC Corporation)
(A1-5) Radial type styrene-butadiene block copolymer (N308 (trade name), styrene content 40% by mass, diblock content 75% by mass, manufactured by Asahi Kasei Chemicals Corporation)
(A2) Styrene block copolymer having a styrene content of more than 10% by weight and less than 35% by weight
(A2-1) Linear type styrene-isoprene block copolymer (Kraton D1161 (trade name), styrene content 15% by mass, diblock content 19% by mass, manufactured by Kraton Corporation)
(A2-2) Linear type styrene-isoprene block copolymer (Vector 4213NS (trade name), styrene content 25% by mass, diblock content 25% by mass, manufactured by TSRC Corporation)
(A2-3) Linear type styrene-isoprene block copolymer (Quintac 3270 (trade name), styrene content 24% by mass, diblock content 67% by mass, manufactured by ZEON CORPORATION)
(A2-4) Linear type styrene-isoprene block copolymer (JH8291 (trade name), styrene content 30% by mass, diblock content 0% by mass (triblock content 100% by mass), manufactured by Jinhai Chemical Corporation)
(A2-5) Linear type styrene-butadiene block copolymer (Asaprene T432 (trade name), styrene content 30% by mass, diblock content 0% by mass (triblock content 100% by mass), manufactured by Asahi Kasei Chemicals Co., Ltd.)
(A2-6) Linear type styrene-butadiene block copolymer (Asaprene T436 (trade name), styrene content 32% by mass, diblock content 50% by mass, manufactured by Asahi Kasei Chemicals Co., Ltd.)
(B) Tackifying resin
(B1) Natural resin
(B1-1) Rosin ester (SYLVALITE 9100 (trade name), biomass degree 93%, manufactured by Kraton Corporation)
(B1-2) Rosin ester (KEL100 (trade name), biomass degree 85%, manufactured by Guangdong KCMO Corporation)
(B1-3) Styrene-modified terpene (SYLVARES 6100 (trade name), biomass degree 69%, manufactured by Kraton Corporation)
(B1-4) Terpene polymer (SYLVARES TRM1115 (trade name), biomass degree 100%, manufactured by Kraton Corporation)
(B2) Petroleum resin
(B2-1) Hydrogenated dicyclopentadiene/C9 copolymer resin (T-Rez HB125 (trade name), softening point 125° C., manufactured by ENEOS Corporation)
(B2-2) Hydrogenated dicyclopentadiene resin (HD1120 (trade name), softening point 120° C., manufactured by Zibo Luhua Hongjin New Material Corporation)
(B2-3) Hydrogenated C5 resin (Eastotac H130 (trade name), softening temperature 130° C., manufactured by Eastman Corporation)
(B2-4) Hydrogenated C5/C9 copolymer resin (SUKOREZ SU420 (trade name), softening point 120° C., manufactured by KOLON Industries, Inc.)
(B2-5) α-methylstyrene resin (Plastolyn 290LV (trade name), softening point 140° C., manufactured by Eastman Corporation)
(B2-6) Hydrogenated dicyclopentadiene resin (T-Rez HC103 (trade name), softening point 103° C., manufactured by ENEOS Corporation)
(B2-7) Hydrogenated dicyclopentadiene resin (HD1100 (trade name), softening point 100° C., manufactured by Zibo Luhua Hongjin New Material Corporation)
(B2-8) Hydrogenated dicyclopentadiene resin (ECR5600 (trade name), softening point 103° C., manufactured by Exxon Mobil Corporation)
(B2-9) Hydrogenated dicyclopentadiene resin (Imarve 5100 (trade name), softening point 100° C., manufactured by Idemitsu Kosan Co., Ltd.)
(B2-10) Hydrogenated C9 resin (Alcon M100 (trade name), softening point 100° C., manufactured by Arakawa Chemical Industries, Ltd.)
(C) Plasticizer
(C1) Naphthenic oil (“KN4010” (trade name), manufactured by Petro China Company Limited)
(C2) Paraffinic oil (Diana Fresia S32 (trade name), manufactured by Idemitsu Kosan Co., Ltd.)
(D) Stabilizer
(D1) Phenolic antioxidant (SUMILIZER G4 (manufactured by SUMITOMO CHEMICAL COMPANY, LIMITED))
(D2) Phenolic Antioxidant (Irganox 1010 (manufactured by BASF Corporation))
(D3) Sulfur antioxidant (SUMILIZER TPD (manufactured by SUMITOMO CHEMICAL COMPANY, LIMITED))

### [Preparation of Hot Melt Adhesives of Examples and Comparative Examples]

The above-mentioned components (A) to (D) were formulated in the ratios shown in Table 1, and melted and mixed at about 150° C. for 2 hours using a universal stirrer to prepare hot melt adhesives of Examples and Comparative Examples. Numerical values relating to the compositions (formulations) of the hot melt adhesives shown in the table are all parts by mass.

TABLE 1

| | | Example | | | | | | | |
|---|---|---|---|---|---|---|---|---|---|
| | | 1 | 2 | 3 | 4 | 5 | 6 | 7 | 8 |
| (A) Styrene block copolymer | | | | | | | | | |
| (A1) Styrene: 35-50% | | | | | | | | | |
| (A1-1) | SIS, St: 48%, Tri-block (QTC 3390) | | | 3 | | | | | |
| (A1-2) | SIS, St: 45%, Tri-block (LCY 5562) | 16 | 16 | | 20 | 16 | 16 | 16 | 16 |
| (A1-3) | SBS, St: 43%, Di-block: 60% (LCY 3545) | 20 | | | 17 | 20 | 20 | | 20 |
| (A1-4) | SBS, St: 37%, Di-block: 70% (Taipol 4270) | | 26 | 31 | | | | 26 | |
| (A1-5) | Radial SBS, St: 40%, Di-block: 75% | | | | | | | | |
| | (N308) | | | | | | | | |
| (A2) Styrene: 10-35% | | | | | | | | | |
| (A2-1) | SIS, St: 15%, Di-block: 19% (Kraton | | | | | | | 7 | |
| | D1161) | | | | | | | | |
| (A2-2) | SIS, St: 25%, Di-block: 25% (Vector | | 7 | | | | | | |
| | 4213NS) | | | | | | | | |
| (A2-3) | SIS, St: 24%, Di-block: 67% (QTC 3270) | | | | | | 12 | | |
| (A2-4) | SIS, St: 30%, Tri-block: (JH8291) | 12 | | | 12 | | | | 12 |
| (A2-5) | SBS, St: 30%, Tri-block: (Asaprene T432) | | | | | 12 | | | |
| (A2-6) | SBS, St: 32%, Di-block: 50% (Asaprene | | | 17 | | | | | |
| | T436) | | | | | | | | |
| (B) Tackifying resin | | | | | | | | | |
| (B1) Natural resin | | | | | | | | | |
| (B1-1) | Rosin ester BD %: 93% (SYLVALITE 9100) | 75 | 73 | | 44 | 85 | 56 | 73 | 100 |
| (B1-2) | Rosin ester BD %: 85% (KE100L) | | | 25 | | | | | |
| (B1-3) | Styrene modified terpene BD %: 69% | | | | 17 | | | | |
| | (SYLVARES 6100) | | | | | | | | |
| (B1-4) | Polyterpene BD %: 100% (SYLVARES | | | | 22 | | | | |
| | TRM1115) | | | | | | | | |
| (B2) Petroleum resin | | | | | | | | | |
| (B2-1) | Hydrogenated DCPD/C9 (T-Rez HB125, | | 27 | 59 | | 10 | 22 | 27 | |
| | softening point: 125° C.) | | | | | | | | |
| (B2-2) | Hydrogenated DCPD (HD1120, softening | 25 | | | 17 | | | | |
| | point: 120° C.) | | | | | | | | |
| (B2-3) | Hydrogenated C5 (Eastotac H130, | | | | | | | | |
| | softening point: 130° C.) | | | | | | | | |
| (B2-4) | Hydrogenated C5/C9 (SUKOREZ SU420, | | | | | | | | |
| | softening point: 120° C.) | | | | | | | | |
| (B2-5) | α-Methyl styrene (Plastolyn 290LV, | | | 7 | | 5 | 5 | | |
| | softening point: 140° C.) | | | | | | | | |
| (B2-6) | Hydrogenated DCPD (T-Rez HC103, | | | 9 | | | 17 | | |
| | softening point: 103ºC, aromatic content: | | | | | | | | |
| | 10.8%) | | | | | | | | |
| (B2-7) | Hydrogenated DCPD (HD1100, softening | | | | | | | | |
| | point: 100° C., aromatic content: 0%) | | | | | | | | |
| (B2-8) | Hydrogenated DCPD (ECR5600, | | | | | | | | |
| | softening point: 103ºC, aromatic content: | | | | | | | | |
| | 9.8%) | | | | | | | | |
| (B2-9) | Hydrogenated DCPD (I-S100, softening | | | | | | | | |
| | point: 100° C.) | | | | | | | | |
| (B2-10) | Hydrogenated C9 (A-M100, softening | | | | | | | | |
| | point: 100° C.) | | | | | | | | |
| (B) Content of (B1) in tackifying resin (%) | | 75 | 73 | 25 | 83 | 85 | 56 | 73 | 100 |
| (C) Oil (Plasticizer) | | | | | | | | | |
| (C1) | Naphthene (KN4010) | 19 | 19 | | 24 | 21 | 21 | 19 | 19 |
| (C2) | Paraffin (S32) | | | 19 | | | | | |
| (D) Stabilizer | | | | | | | | | |
| (D1) | Phenolic antioxidant (GM) | 0.3 | 0.3 | 0.3 | | 0.3 | | 0.3 | 0.3 |
| (D2) | Phenolic antioxidant (Irganox 1010) | | | | 1.7 | | 1.7 | | |
| (D3) | Sulfur antioxidant (TPD) | 0.5 | 0.5 | 0.5 | | 0.5 | | 0.5 | 0.5 |

| | | | | | | | | |
|---|---|---|---|---|---|---|---|---|
| Total | 167.8 | 168.8 | 170.8 | 174.7 | 169.8 | 170.7 | 168.8 | 167.8 |
| Biomass degree of hot melt adhesive | 42 | 40 | 13 | 43 | 47 | 31 | 40 | 56 |

TABLE 2

| | | Comparative Example | | | | | |
|---|---|---|---|---|---|---|---|
| | | 1 | 2 | 3 | 4 | 5 | 6 |
| (A) Styrene block copolymer | | | | | | | |
| (A1) Styrene: 35-50% | | | | | | | |
| (A1-1) | SIS, St: 48%, Tri-block (QTC 3390) | | | | | | 30 |
| (A1-2) | SIS, St: 45%, Tri-block (LCY 5562) | 28 | | 16 | | 3 | |
| (A1-3) | SBS, St: 43%, Di-block: 60% (LCY 3545) | 20 | | | 26 | 28 | |
| (A1-4) | SBS, St: 37%, Di-block: 70% (Taipol 4270) | | | 26 | | | |
| (A1-5) | Radial SBS, St: 40%, Di-block: 75% (N308) | | | | 15 | | |
| (A2) Styrene: 10-35% | | | | | | | |
| (A2-1) | SIS, St: 15%, Di-block: 19% (Kraton D1161) | | | | | | 30 |
| (A2-2) | SIS, St: 25%, Di-block: 25% (Vector 4213NS) | | | 7 | | | |
| (A2-3) | SIS, St: 24%, Di-block: 67% (QTC 3270) | | | | | | |
| (A2-4) | SIS, St: 30%, Tri-block: (JH8291) | | 48 | | | | |
| (A2-5) | SBS, St: 30%, Tri-block: (Asaprene T432) | | | | | | |
| (A2-6) | SBS, St: 32%, Di-block: 50% (Asaprene T436) | | | | 5 | | |
| (B) Tackifying resin | | | | | | | |
| (B1) Natural resin | | | | | | | |
| (B1-1) | Rosin ester BD %: 93% (SYLVALITE 9100) | 75 | 75 | | 17 | | |
| (B1-2) | Rosin ester BD %: 85% (KE100L) | | | | | | |
| (B1-3) | Styrene modified terpene BD %: 69% | | | | | | |
| | (SYLVARES 6100) | | | | | | |
| (B1-4) | Polyterpene BD %: 100% (SYLVARES | | | | | | |
| | TRM1115) | | | | | | |
| (B2) Petroleum resin | | | | | | | |
| (B2-1) | Hydrogenated DCPD/C9 (T-Rez HB125, | | | 27 | | | |
| | softening point: 125° C.) | | | | | | |
| (B2-2) | Hydrogenated DCPD (HD1120, softening point: | 25 | 25 | | | | |
| | 120° C.) | | | | | | |
| (B2-3) | Hydrogenated C5 (Eastotac H130, softening | | | | | | |
| | point: 130° C.) | | | | | | |
| (B2-4) | Hydrogenated C5/C9 (SUKOREZ SU420, | | | | 17 | | |
| | softening point: 120° C.) | | | | | | |
| (B2-5) | α-Methyl styrene (Plastolyn 290LV, softening | | | | | 8 | |
| | point: 140° C.) | | | | | | |
| (B2-6) | Hydrogenated DCPD (T-Rez HC103, softening | | | | | | |
| | point: 103° C., aromatic content: 10.8%) | | | | | | |
| (B2-7) | Hydrogenated DCPD (HD1100, softening point: | | | 73 | | | |
| | 100° C., aromatic content: 0%) | | | | | | |
| (B2-8) | Hydrogenated DCPD (ECR5600, softening point: | | | | | 92 | |
| | 103° C., aromatic content: 9.8%) | | | | | | |
| (B2-9) | Hydrogenated DCPD (I-S100, softening point: | | | | 66 | | |
| | 100° C.) | | | | | | |
| (B2-10) | Hydrogenated C9 (A-M100, softening point: | | | | | | |
| | 100° C.) | | | | | | |
| (B) Content of (B1) in tackifying resin (%) | | 75 | 75 | 0 | 17 | 0 | 0 |
| (C) Oil (Plasticizer) | | | | | | | |
| (C1) | Naphthene (KN4010) | 19 | 19 | 19 | | 23 | |
| (C2) | Paraffin (S32) | | | | 19 | | 39.5 |
| (D) Stabilizer | | | | | | | |
| (D1) | Phenolic antioxidant (GM) | 0.3 | 0.3 | 0.3 | 0.3 | | |
| (D2) | Phenolic antioxidant (Irganox 1010) | | | | | 0.8 | 0.5 |
| (D3) | Sulfur antioxidant (TPD) | 0.5 | 0.5 | 0.5 | 0.5 | | |

| | | | | | | |
|---|---|---|---|---|---|---|
| Total | 167.8 | 167.8 | 168.8 | 165.8 | 154.8 | 100 |
| Biomass degree of hot melt adhesive | 42 | 42 | 0 | 9 | 0 | 0 |

With respect to the hot melt adhesives of Examples and Comparative Examples thus obtained, the melt viscosity, coatability, and applied length retention properties of the rubber threads were examined. The evaluation results are shown in the tables. The above characteristics were evaluated by the following method.

### [Melt Viscosity]

The hot melt adhesive was heated and melted, and the viscosity in a molten state at 140° C., 160° C. and 180° C. was measured with a Brookfield RVT viscometer (spindle No. 27).

### [Coatability]

A hot melt adhesive was applied to a rubber thread by V-slit coating, and the rubber thread was stretched and applied to a nonwoven fabric, which served as a coating sample. The coating temperature was set to 160° C.

The open time of the coating device was 0.4 seconds, and the coating amount was 0.04 g/m (discharge rate was 12 g/min).

Commercially available products shown below were used as the rubber thread and the nonwoven fabric. Rubber thread: “LYCRA” (registered trademark), 620detex urethane thread, manufactured by TORAY OPELONTEX CO., LTD.

Nonwoven fabric: A polylactic acid-based nonwoven fabric having a polylactic acid content of 100% by mass, manufactured by FITESA Corporation.

In addition, the stretch ratio of the rubber thread was 3.0 times. The evaluation criteria are as follows.
A (Good): There is no spatter or dripping of the hot melt adhesive, and uniform coating on rubber threads is possible (melt viscosity at 160° C. is 2000 to 8000 mPa·s).
B (Fair): Due to the high viscosity of the hot melt adhesive, uniform coating on the rubber thread is difficult (melt viscosity at 160° C. is 8000 to 50000 mPa·s).
C (Fail): Due to the low viscosity of the hot melt adhesive, seepage occurs when coating on the rubber thread (melt viscosity at 160° C. is less than 2000 mPa·s).
D (Bad): The viscosity of the hot melt adhesive is too high, the discharge from the nozzle is difficult, and coating is impossible (melt viscosity at 160° C. exceeds 50000 mPa·s).

### [Peel Strength Against Polyethylene Film (Adhesiveness)]

A hot melt adhesive was applied to a polyethylene terephthalate (PET) film having a thickness of 50 μm to prepare an adhesive layer having a thickness of 50 μm. This was formed to have a width of 25 mm, and it served as a test piece. This test piece was applied to a polyethylene film having a thickness of 100 μm at 20° C. When pasting them together, a roller weighing 2 kg was brought into contact with the PET film at a speed of 5 mm/sec. The test piece was left at 20° C. for 1 day. After being left to stand, a peel test was conducted under the conditions of 40° C. and a tensile speed of 300 mm/min, and the strength at which the test piece was peeled from the polyethylene (PE) film was measured. The evaluation criteria are as follows.
A (Good): Peel strength exceeds 1000 (g/25 mm)
B (Fair): Peel strength is 800 (g/25 mm) or more, 1000 (g/25 mm) or less
C (Fail): Peel strength is 400 (g/25 mm) or more and less than 800 (g/25 mm)
D (Bad): Peel strength is less than 400 (g/25 mm)

### [Evaluation of Applied Length Retention Properties of Rubber Thread Using Polylactic Acid Nonwoven Fabric (Creep Resistance)]

A rubber thread applied to a polylactic acid (PLA)-based nonwoven fabric served as a sample, and this sample was cut to a length of 250 mm to 300 mm, and applied to a corrugated paperboard in a completely stretched state. Next, any two points where the rubber length of the applied test piece was 200 mm were marked with an oil-based pen, the rubber was cut at these marks, followed by being left at 40° C. for 4 hours.

After 4 hours, the length of the stretched and applied rubber thread was measured, and the applied length retention rate of the rubber thread was calculated. The formula for calculating the retention rate is shown below.

The evaluation criteria are as follows.

Retention rate (%)=Rubber length after 4 hours (mm)×100/200 [Mathematical Formula 1]
A (Good): Applied length retention rate after 4 hours exceeds 90%
B (Fair): Applied length retention rate after 4 hours exceeds 90%
C (Fail): Applied length retention rate after 4 hours is 80% or more and less than 85%
D (Bad): Applied length retention rate after 4 hours is less than 80%

TABLE 3

| | | Example | | | | | | | |
|---|---|---|---|---|---|---|---|---|---|
| | | 1 | 2 | 3 | 4 | 5 | 6 | 7 | 8 |
| Melt | 140° C. | 10400 | 12900 | 24700 | 12700 | 19600 | 12600 | 12800 | 8200 |
| viscosity | 160° C. | 3840 | 4990 | 9550 | 4060 | 7200 | 4600 | 4440 | 3100 |
| (mPa · s) | 180° C. | 1790 | 2400 | 4730 | 1810 | 3340 | 2150 | 2030 | 1470 |

| | | | | | | | | |
|---|---|---|---|---|---|---|---|---|
| V-slit coatability | A | A | B | A | A | A | A | A |
| (coating at 160° C.) | | | | | | | | |
| PE peel strength | A | A | A | A | B | B | A | A |
| (g/25 mm, 40° C., | 1070 | 1460 | 1250 | 1100 | 820 | 840 | 1450 | 1270 |
| tensile speed 300 | | | | | | | | |
| mm/minute) | | | | | | | | |
| Applied length | A | A | B | A | A | A | B | B |
| retention properties | 92% | 91% | 85% | 94% | 96% | 97% | 85% | 90% |
| of thread rubber | | | | | | | | |
| (with respect to PLA | | | | | | | | |
| nonwoven fabric, | | | | | | | | |
| 40° C., 4 hours) | | | | | | | | |

TABLE 4

| | | Comparative Example | | | | | |
|---|---|---|---|---|---|---|---|
| | | 1 | 2 | 3 | 4 | 5 | 6 |
| Melt | 140° C. | 11500 | 13700 | 20500 | 7380 | 3490 | 742500 |
| viscosity | 160° C. | 4000 | 5460 | 6250 | 3030 | 1370 | 104000 |
| (mPa · s) | 180º C. | 1770 | 2660 | 2840 | 1530 | 660 | 35200 |

| | | | | | | |
|---|---|---|---|---|---|---|
| V-slit coatability | A | A | A | A | C | D |
| (coating at 160° C.) | | | | | | |
| PE peel strength | D | A | B | A | C | — |
| (g/25 mm, 40° C., | 386 | 1280 | 920 | 1270 | 440 | Strength |
| tensile speed | | | | | | was too |
| 300 mm/minute) | | | | | | low, and |
| | | | | | | not |
| | | | | | | measur- |
| | | | | | | able |
| Applied length | A | D | D | D | C | — |
| retention properties | 95% | 74% | 79% | 70% | 84% | Vis- |
| of thread rubber | | | | | | cosity |
| (with respect to | | | | | | was too |
| PLA nonwoven | | | | | | high, and |
| fabric, 40° C., | | | | | | not |
| 4 hours) | | | | | | coatable |

As shown in Tables 3 and 4, the hot-melt adhesives of Examples 1 to 8 have a good balance of the coatability, adhesiveness (peel strength), and applied length retention rate (creep resistance) of the rubber thread. The hot-melt adhesives of Comparative Examples 1 to 6 are evaluated as C or D in any of the coatability, adhesiveness (peel strength) of the hot melt adhesive, and the applied length retention rate (creep resistance) of the rubber thread.

It was verified that when the hot melt adhesive contained the component (A1), the component (A2), and the component (B1), and the formulation amount of the component (B1) was high, the balance of the coatability, adhesiveness of the hot melt adhesive, and the applied length retention rate of the rubber thread was improved.

### INDUSTRIAL APPLICABILITY

The present invention provides a hot melt adhesive and a disposable product obtained by applying the hot melt adhesive. The hot melt adhesive of the present invention is suitable for manufacturing disposable products, and in particular, is able to bond and keep an elastic material to a material containing biodegradable plastics. The disposable product body provided with a polylactic acid-based nonwoven fabric, which is a kind of biodegradable plastic, is easy to dispose of and has a small environmental load.

1: A hot melt adhesive comprising (A) a thermoplastic block copolymer which is a copolymer of vinyl aromatic hydrocarbons and conjugated diene compounds, and (B) a tackifying resin, wherein
(A) the thermoplastic block copolymer comprises:
(A1) a styrene block copolymer having a styrene content of 35 to 50% by mass; and
(A2) a styrene block copolymer having a styrene content of more than 10% by mass and less than 35% by mass;
(B) the tackifying resin comprises:
(B1) a natural resin; and
the component (B1) being contained in an amount of 20 parts by mass or more based on 100 parts by mass of the component (B).

2: The hot melt adhesive according to claim 1, wherein (B1) the natural resin comprises a rosin ester.

3: The hot melt adhesive according to claim 1, wherein (B) the tackifying resin further comprises (B2) a petroleum resin.

4: The hot melt adhesive according to claim 3, wherein (B2) the petroleum resin comprises a hydrogenated petroleum resin having a softening point of 100° C. or more.

5. (canceled)

6: A disposable product comprising the hot melt adhesive according to claim 1.

7: The disposable product of claim 6 further comprising an elastic material and a biodegradable plastic.

8: The disposable product of claim 6, wherein the elastic material is a rubber thread.
